(19) United States
(12) Patent Application Publication
(10) Pub. No.: US 2025/0309315 A1
(43) Pub. Date: Oct. 2, 2025

(54) FUEL CELL MANIFOLD STRUCTURE

(71) Applicant: HONDA MOTOR CO., LTD., Tokyo (JP)

(72) Inventors: Makoto YAMAZAKI, Wako-shi (JP); Jin KOBAYASHI, Tokyo (JP)

(21) Appl. No.: 19/064,161

(22) Filed: Feb. 26, 2025

(30) Foreign Application Priority Data
Mar. 29, 2024 (JP) 2024-058288

(51) Int. Cl. H01M 8/2483

(52) U.S. Cl. CPC H01M 8/2483

(57) ABSTRACT

Each of unit cells includes a fluid passage which is provided between a membrane electrode structure and a separator; and a connection passage which connects a communication hole and a fluid passage. A fluid manifold is extended in a laminate direction of the unit cells of the laminated cell stack to allow communication holes formed to open in the respective unit cells to communicate with one another, and supplies a fluid to each unit cell. The fluid manifold includes: an inlet portion which is provided with an inlet through which the fluid is allowed flow into one end communicating with an outside of a stack case; and a closed portion on another end which is located on an opposite side from the inlet portion. Then, the inlet portion is provided with a biasing portion which biases the fluid flowing into the fluid manifold to the connection passage side.

### CROSS REFERENCE TO RELATED APPLICATION

This application is based upon and claims priority from the Japanese Patent Application No. 2024-058288, filed on Mar. 29, 2024, the entire contents of which are incorporated herein by reference.

### BACKGROUND OF THE INVENTION

### 1. Field of the Invention

The present invention relates to a fuel cell manifold structure.

### 2. Description of the Related Art

A conventional fuel cell manifold structure includes an internal manifold which is formed to communicate in a laminate direction inside of a fuel cell stack which is formed by laminating a plurality of fuel cells. In addition, the manifold structure includes an external fluid passage through which to supply a fluid to the internal manifold, and a connection portion which connects the external fluid passage to the internal manifold. Moreover, each fuel cell includes an in-cell fluid passage which is connected to the internal manifold from an orthogonal direction. There is also a conventional fuel cell which is configured to generate a swirl flow which swirls along an inner wall of a manifold inside an internal manifold by using an energy of the fluid flowing from an external fluid passage into the internal manifold in order to make uniform the amount of the fluid supplied to each in-cell fluid passage (see, for example, JP4872918B2).

The above-described fuel cell manifold structure of JP4872918B2 generates a swirl flow so as not to generate unevenness in distribution of the fluid. However, such a structure causes a fast flow speed in portions corresponding to the unit cells on the inlet portion side in the laminate direction of the unit cells, so that the fluid passes therethrough.

In addition, it is necessary to improve the power generation efficiency by making the static pressure distribution uniform inside the fluid manifold. For this reason, for example, there is one which generates a swirl flow by changing the size of an external manifold included in an external fluid passage or the shape of connection. However, there has been such a problem that when the size of the external manifold is increased or the shape of connection is changed, a protrusion dimension is increased, so that the space efficiency decreases.

In addition, there is one in which a separate component such as a spacer having a large flow resistance is provided inside an internal manifold (also referred to as a fluid manifold). Such a configuration has such a problem that it is necessary to change the shape of a fuel cell stack (also referred to as a laminated cell stack) which forms the fluid manifold, and unit cells having the same shape cannot be used.

Moreover, near an end plate which closes a side opposite from the inlet portion, the flow rate is equal between a position close to an active region and a position away from the active region. Here, the active region indicates a region configured with a membrane electrode assembly which is located in the center of the membrane electrode structure among the unit cells laminated in the laminated cell stack.

For this reason, the fluid which has bounced back on the end plate and is flowing in the direction of the inlet side interferes with the fluid which is flowing toward the end plate, thus impairing a smooth flow.

In this way, in each portion in the direction in which the unit cells are laminated, a static pressure distribution inside the fluid manifold is disturbed, making it difficult to make uniform the fluid amount to be supplied to each unit cell, and a further improvement has been demanded.

An object of the present proposal is to provide a fuel cell manifold structure which can improve power generation efficiency with a simple configuration.

### SUMMARY OF THE INVENTION

To solve the above-described problems, a fuel cell manifold structure of the present invention comprises: a laminated cell stack which is provided with an active region by laminating a plurality of unit cells each including a membrane electrode structure and a separator. In addition, the fuel cell manifold structure includes a stack case in which the laminated cell stack is housed. Moreover, the manifold structure includes a fluid manifold which is extended in a laminate direction of the unit cells of the laminated cell stack to allow communication holes formed to open in the respective unit cells to communicate with one another, and supplies a fluid to each unit cell. Each of the unit cells includes: a fluid passage which is provided between the membrane electrode structure and the separator; and a connection passage which connects the communication hole and the fluid passage. The fluid manifold includes: an inlet portion which is provided with an inlet through which the fluid is allowed to flow into one end communicating with an outside of the stack case; and a closed portion which is located on another end opposite from the inlet portion. Then, the inlet portion is provided with a biasing portion which biases the fluid flowing into the fluid manifold to the connection passage side.

According to the present invention, a fuel cell manifold structure which can improve power generation efficiency with a simple configuration can be provided.

### BRIEF DESCRIPTION OF THE DRAWINGS

FIG. 1 is a vertical sectional view of a fuel cell for explaining an entire configuration in a fuel cell manifold structure of a first embodiment.

FIG. 2 is a vertical sectional view for explaining a configuration of an inlet portion in the fuel cell manifold structure of the first embodiment.

FIG. 3 is a vertical sectional view for explaining a flow of a fluid inside a fluid manifold of the first embodiment.

FIG. 4 is an arrow view in an IV direction in FIG. 3 showing a shape of the inlet portion inside the fluid manifold of the first embodiment.

FIG. 5 is a vertical sectional view for explaining a flow of a fluid inside a fluid manifold shown as a comparative example.

FIG. 6 is a schematic side view showing an entire configuration of the fuel cell for explaining the flow of the fluid with arrows.

FIG. 7 is a graph showing a change in static pressure from the inlet portion side to the closed portion side in the fluid manifold of the fuel cell.

FIG. 8 is a vertical sectional view for explaining a configuration of an inlet portion in a fluid manifold of a second embodiment.

FIG. 9 is a vertical sectional view for explaining a configuration of an inlet portion in a fluid manifold of a third embodiment.

### DETAILED DESCRIPTION OF THE EMBODIMENTS

Hereinafter, embodiments of a fuel cell manifold structure of the present invention will be described by using the drawings as appropriate. The same constituent elements are denoted by the same reference signs, and repetitive description is omitted.

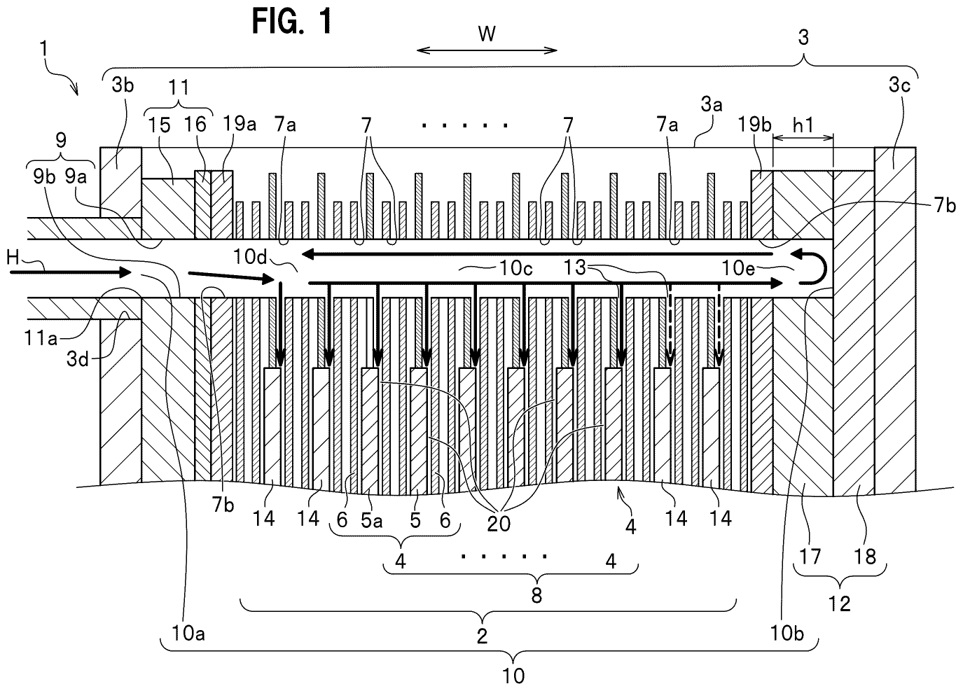

The fuel cell manifold structure of the first embodiment shown in FIG. 1 includes a laminated cell stack 2 which is provided with an active region 8 by laminating a plurality of unit cells 4 each including a membrane electrode structure 5 and a separator 6 in a laminate direction W. In addition, the manifold structure includes a stack case 3 in which the laminated cell stack 2 is housed. In the embodiments, the active region 8 is a region configured with membrane electrode assemblies 5a which are situated in the middle among the membrane electrode structure 5 in the unit cells 4 laminated in the laminated cell stack 2. In the manifold structure of the embodiment, the active region 8 is a region which does not contain a portion where dummy cells 14 which will be described later are laminated.

The stack case 3 includes a box-shaped housing 3a, an inlet-side end frame 3b which forms part of an inlet-side end unit, and a closed portion-side end frame 3c which forms part of a closed portion-side end unit.

The inlet-side end unit of the first embodiment further includes a pipe-side insulator 15 and a cell-side inlet insulator 16 which form an inlet portion 11, which is described later. In addition, the closed portion-side end unit of the first embodiment further includes a cell-side insulator 17 and an end frame-side insulator 18 which form a closed portion 12.

Each unit cell 4 includes a membrane electrode structure 5 and separators 6 which are disposed on both sides of the membrane electrode structure 5. In addition, the unit cell 4 is provided with a fluid passage 20 between the membrane electrode structure 5 and the separator 6. In addition, the unit cell 4 includes a connection passage 13 which connects a communication hole 7 and the fluid passage 20.

Then, the membrane electrode structure 5 generates electric power by supplying gases of different types such as fluids of hydrogen and oxygen, for example, to both sides. In addition, a fluid for cooling (coolant) is supplied between the unit cells 4 (between the separator 6 and the separator 6).

The membrane electrode structure 5 includes a membrane electrode assembly 5a having an outer peripheral portion surrounded by a frame member 5b, and the peripheries of these membrane electrode assemblies become the active region 8. When electric power is generated, a fluid H is supplied to a fluid passage 20 formed between the membrane electrode assembly portion and each of the separators 6 provided on both sides thereof. In this way, each unit cell 4 generates electric power by causing hydrogen oxidation reaction (HOR) on the negative electrode side (anode) and oxygen reduction reaction (ORR) on the positive electrode side (cathode) in the membrane electrode assembly portion.

The voltages generated by the respective unit cells 4 become an output voltage of the fuel cell 1 between a pair of positive and negative electrodes 19a and 19b which are disposed on the left and right sides of the active region 8.

Hence, it is desirable for the fuel cell 1 that the distribution of flow rates of the fluid H to be supplied to the membrane electrode assembly portions such that each unit cell 4 uniformly generates electric power in order to stabilize the output voltage and obtain favorable power generation efficiency.

Then, the manifold structure of the fuel cell 1 includes a fluid manifold 10 which allows the communication holes 7 formed to open in the respective unit cells 4 laminated in a laminate direction W to communicate with one another.

The fluid manifold 10 includes a distribution passage 10c which is extended in the laminate direction W of the unit cells 4 of the laminated cell stack, an inlet-side distribution passage 10d which is connected to the inlet portion 11 side of the distribution passage 10c in the laminate direction W, and a closed-side area 10e which is connected to the closed portion 12 side of the distribution passage 10c, which communicate with one another.

Specifically, each unit cell 4 included in the laminated cell stack 2 has the communication hole 7 formed at a position corresponding to a communication hole 7b formed in each electrode 19a, 19b.

Among these, the communication hole 7 of the separator 6 is formed in an outer peripheral portion corresponding to the communication hole 7 of the membrane electrode structure 5. In addition, a communication hole of the membrane electrode structure 5 is formed in a resin-made frame portion provided in the outer peripheral portion, and is formed at a position corresponding to the communication hole 7 of the separator 6.

Then, these communication holes 7 are disposed at positions which do not overlap with the membrane electrode assemblies 5a of the corresponding membrane electrode structures 5.

Moreover, the plurality of unit cells 4 are laminated in the laminate direction W and held between the electrode 19a on the inlet portion 11 side and the electrode 19b on the closed portion 12 side. In this way, the laminated cell stack 2 is formed. The communication holes 7 are caused to coincide with each other in the laminate direction W, so that the laminated cell stack 2 forms the distribution passage 10c of the fluid manifold 10. The distribution passage 10c is a passage through which the fluid H is distributed and supplied to the unit cells 4 corresponding to the respective portions in the laminate direction W.

In addition, the fluid manifold 10 includes the inlet-side distribution passage 10d on the inlet portion 11 side of the distribution passage 10c in the laminate direction W. Moreover, the fluid manifold 10 includes the closed-side area 10e on the closed portion 12 side. Then, the distribution passage 10c is connected to the inlet-side distribution passage 10d and the closed-side area 10e such that internal spaces thereof communicate with each other.

Between the membrane electrode structure 5 and the separator 6, the fluid passage 20 for allowing a gas, which is a fuel, to flow therethrough is provided. In addition, between the unit cells 4 (that is, between the separators 6), the fluid passage 20 for allowing a refrigerant to flow therethrough is provided. Then, the unit cell 4 includes a connection passage 13 which connects the communication hole 7 (that is, the fluid manifold 10) and the fluid passage 20.

Note that in the separator 6 and the frame member 5b of the unit cell 4, three communication holes for supply corresponding to two gases and one refrigerant are formed. Then, in the laminated cell stack 2, the three communication holes penetrate in the laminate direction to form three fluid manifolds.

In the present embodiment, as shown in FIG. 1, the fluid manifold 10 for supplying the fluid H to the fluid passages 20 between the membrane electrode structure 5 and the separator 6 on the right side has been described as an example; however, the other two fluid manifolds also have the same structure, and description thereof will be omitted.

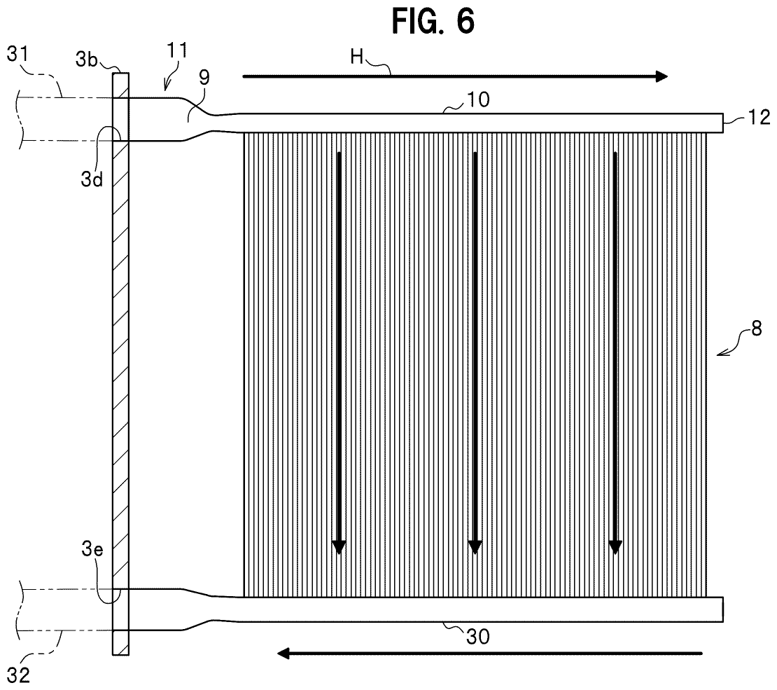

In the fuel cell manifold structure of the first embodiment, as shown in FIG. 6, an external manifold 31 is connected to a case inlet 3d of the inlet-side end frame 3b. In addition, a discharge-side internal manifold 30 which communicates via the fluid passage 20 is provided on the opposite side of the active region 8 from the fluid manifold 10. Moreover, a discharge-side external manifold 32, which is one of external fluid passages, is connected to a case outlet 3e of the inlet-side end frame 3b.

Then, the fuel cell manifold structure is configured such that the fluid which has flowed down through the fluid passages 20 from near the active region 8 is collected at the discharge-side internal manifold 30, and is discharged toward the discharge-side external manifold 32 on the outside.

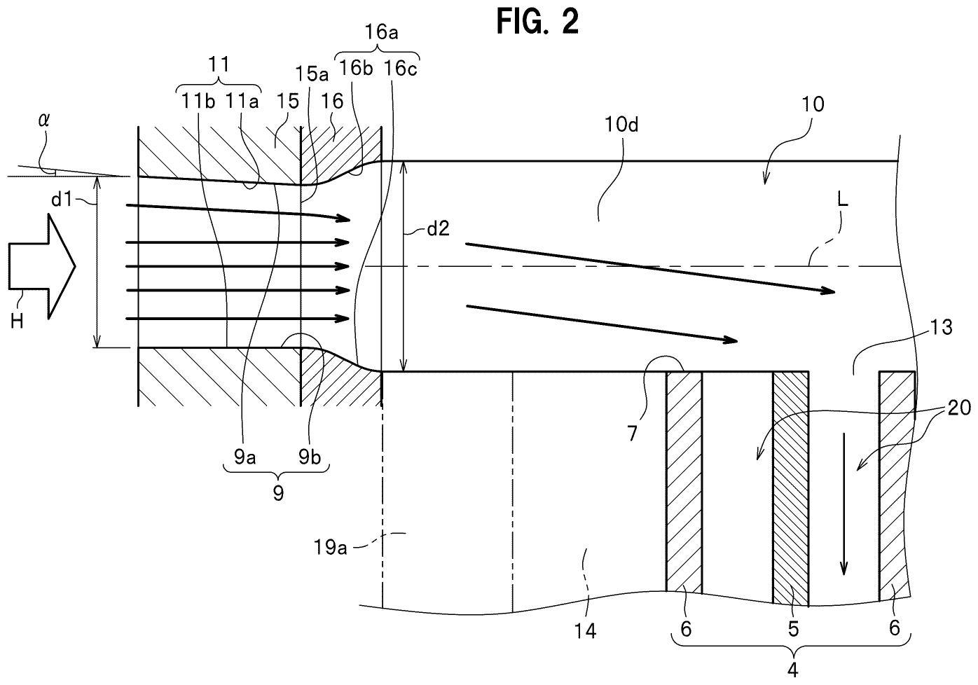

Next, a biasing portion 9 formed in the inlet portion 11 will be described by using FIG. 2 while referring to FIG. 1.

In the inlet portion 11, the pipe-side insulator 15 and the cell-side inlet insulator 16 provided in the inlet-side end unit are disposed. The pipe-side insulator 15 and the cell-side inlet insulator 16 are laminated in the laminate direction W such that the opening portions coincide with each other.

The biasing portion 9 of the first embodiment includes a tapered surface 9a which is formed in the inner wall surface of the pipe-side insulator 15. The tapered surface 9a is formed in an inner wall 11b which is opposite from the connection passage 13 side, and is inclined at an inclination angle α to come closer to the connection passage 13 side as extending from the inlet 11a side toward the closed portion 12 side. In the biasing portion 9 of the first embodiment, the inclination angle α of the tapered surface 9a is set to three degrees, for example. In this way, the inlet portion 11 in which the biasing portion 9 is formed can bias the fluid H flowing into the fluid manifold 10 toward the connection passage 13 side.

In addition, the biasing portion 9 of the first embodiment includes a straight surface 9b in the inner wall 11b of the inlet portion 11. The straight surface 9b is provided on the connection passage 13 side in the inner wall surface of the pipe-side insulator 15. Then, the straight surface 9b is provided on the active region 8 side, and is formed in parallel with the direction of a center axis L of the fluid manifold 10. In this way, the inner wall surface of the inlet portion 11 is asymmetrical between the upper and lower surfaces.

Then, as shown in FIG. 4, the biasing portion 9 of the first embodiment is configured such that the sectional shape of the inlet portion 11 of the fluid manifold 10 is a circular shape. In addition, as shown in FIG. 2, the dimension of the inner diameter of an end portion 15a on the closed portion 12 side of the pipe-side insulator 15 is smaller than the dimension d1 of the inner diameter in the inlet portion 11.

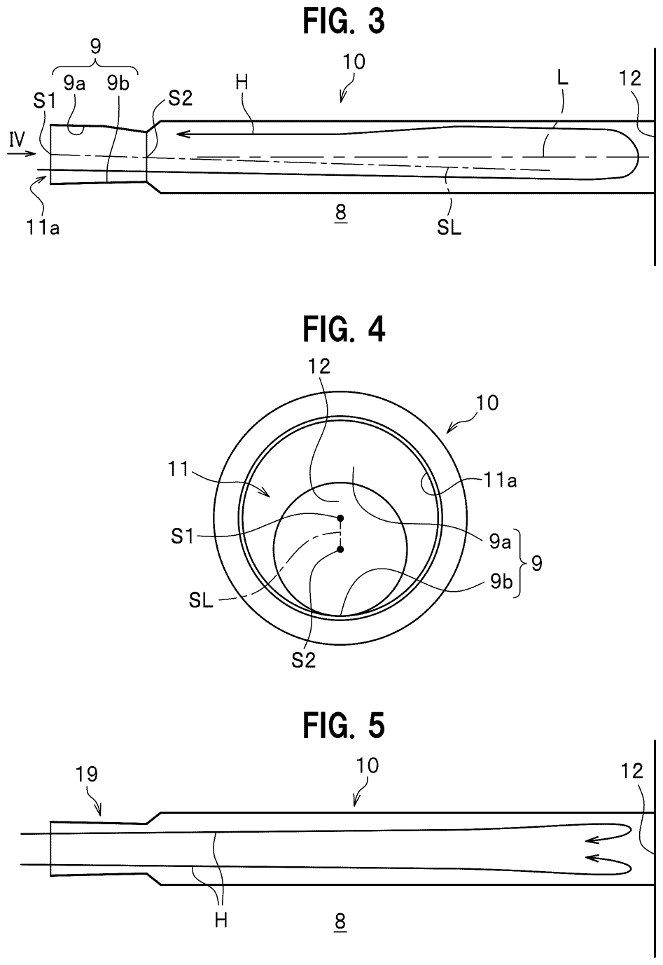

In addition, a center S2 of the end portion on the closed portion 12 side of the biasing portion 9 is eccentric to the connection passage 13 side. Hence, as shown in FIG. 3, a circle center line SL which connects the center S1 on the inlet 11a side and the center S2 on the closed portion 12 side is inclined to come closer to the connection passage 13 side as extending from the inlet 11a side toward the closed portion 12 side.

Moreover, in the first embodiment, an increased diameter portion 16a is provided by utilizing an inner wall surface of the cell-side inlet insulator 16 located at the inlet portion 11. The increased diameter portion 16a of the first embodiment includes a lower inner wall surface 16c on the active region 8 side and an upper inner wall surface 16b on the opposite side. The upper inner wall surface 16b and the lower inner wall surface 16c are symmetrically formed to increase the diameter in the same proportion as extending toward the closed portion 12.

In this way, when passing through the increased diameter portion 16a of the pipe-side insulator 15, the pressure and the flow speed of the fluid H which flows from the biasing portion 9 of the pipe-side insulator 15 into the fluid manifold 10 are reduced.

Then, the end portion on the closed portion 12 side of the increased diameter portion 16a has the largest dimension of the inner diameter d2, and is connected to and communicates with the fluid manifold 10 having the same dimension of the inner diameter d2.

In addition, as shown in FIG. 1, in the closed portion 12 of the first embodiment, a closed portion-side end frame 3c which is provided in the stack case 3, an end frame-side insulator 18, a cell-side insulator 17, and an electrode 19b are laminated in this order from the outer side to form the closed portion-side end unit.

In the first embodiment, the increased diameter portion 16a increases in diameter in the same proportion in the upper inner wall surface 16b and the lower inner wall surface 16c. In addition, the end portion on the closed portion 12 side, which has the largest dimension of the inner diameter d2 in the increased diameter portion 16a, is connected to the fluid manifold 10 having the same dimension of the inner diameter. For this reason, the pressure and the flow speed of the fluid H passing through the biasing portion 9 can be reduced while the direction of the flow is maintained to come closer to the connection passage 13 as the fluid H flows toward the closed portion 12.

In addition, as shown in FIG. 1, the closed portion 12 of the first embodiment is provided with the closed portion-side end unit. The closed portion-side end unit includes the cell-side insulator 17, the end frame-side insulator 18, and the closed portion-side end frame 3c which is mounted on the housing 3a of the stack case 3 from the electrode 19b side to the outer side, which are laminated in the laminate direction W.

In the cell-side insulator 17 of the first embodiment, an opening portion 12a which has a predetermined depth h1 and which communicates with the distribution passage 10c of the fluid manifold 10 is formed. Then, the distribution passage 10c extends the space portion which penetrates inside to a closed-side area 10e which is formed in the opening portion 12a. In this way, the other end 10b on the closed portion side of the fluid manifold 10 becomes an inner wall which faces the closed-side area 10e of the end frame-side insulator 18.

Hence, the fluid H flowing inside the fluid manifold 10 toward the closed portion 12 flows from the opening portion 12a in a direction approaching the closed portion-side end frame 3c. Inside the closed-side area 10e, the fluid H comes into contact with the inner wall of the end frame-side insulator 18 and bounces back to return in a direction opposite to the inlet portion 11 side.

In this way, since the fluid H forms a uniform flow which returns in a substantially U-shape in the longitudinal direction inside the fluid manifold, the fluid having stabilized static pressure distribution returns inside the closed-side area 10e. Hence, the static pressure distribution of the fluid H supplied to the unit cells 4 of the laminated cell stack 2 is made uniform, and the power generation efficiency can be further improved.

In addition, in the laminated cell stack 2 of the first embodiment, a plurality of dummy cells 14 are provided on the inlet portion 11 side or the closed portion 12 side in the laminate direction W. The dummy cells 14 are for adjusting the temperature of the laminated cell stack 2. For this reason, the dummy cell 14 is interposed and laminated in the laminate direction W between each electrode 19a, 19b and the unit cell 4 on the outer side of the unit cell 4 located on each of the closed portion 12 side and the inlet portion 11 side on the connection passage 13 side.

These dummy cells 14 do not cause hydrogen oxidation reaction or oxygen reduction reaction, and thus do not generate electric power even when supplied with the fluid H around these.

Then, the dummy cells 14 are disposed near the inlet-side distribution passage 10d or near the closed-side area 10e where the static pressure distribution is unlikely to be stabilized at both ends of the distribution passage 10c of the fluid manifold 10. In this way, the fluid H which has disturbed static pressure distribution is distributed to the dummy cells 14 via the respective connection passages. Hence, the fluid which has stabilized static pressure distribution with a small amount of disturbance is distributed to the unit cells 4 located between the dummy cells 14 and 14 on both ends. Therefore, the power generation efficiency can be further improved.

In the fuel cell manifold structure of the first embodiment configured as described above, as shown in FIG. 2, by the biasing portion 9 of the inlet portion 11, the straight surface 9b provided in the inner wall 11b is in parallel with the center axis L of the fluid manifold 10, and the tapered surface 9a of the inner wall 11b on the opposite side from the connection passage 13 side is inclined at the inclination angle α=three degrees to become closer to the connection passage 13 side as extending from the inlet 11a side toward the closed portion 12.

For this reason, the fluid H on the connection passage 13 side which passes through the inlet portion 11 is biased to come closer to the connection passage 13 side as flowing from the inlet 11a side toward the closed portion 12 when flowing into the distribution passage 10c toward the closed portion 12 side.

That is, in the first embodiment, the flow rate of the fluid H flowing into the fluid manifold 10 increases at a position close to the connection passage 13.

In addition, the flow rate at a position away from the connection passage 13 side relatively decreases. This makes it possible to shift the timings at which the flow of the fluid H bounces back at the closed portion 12 of the other end 10b located on the opposite side from the inlet portion 11.

Hence, as shown in FIG. 3, the fluid H which has bounced back at the closed portion 12 of the other end 10b can flow by the fluid H which is flowing toward the closed portion 12 without interference. Therefore, the occurrence of disturbance near the closed portion 12 is suppressed.

In this way, the fluid manifold 10 of the first embodiment can suppress the occurrence of disturbance in the closed-side area 10e near the closed portion 12 and thus allow the fluid to return in the direction of the inlet portion 11 smoothly at a position away from the connection passage 13 side.

In addition, near the inlet portion 11, the flow rate of the fluid H flowing into the fluid manifold 10 is smaller on the opposite side than the connection passage 13 side due to the biasing.

Moreover, in the first embodiment, the diameter of the fluid manifold 10 on the inlet portion 11 side is increased by the increased diameter portion 16a of the cell-side inlet insulator 16. For this reason, the pressure and the flow speed of the fluid H which has separated from the upper inner wall surface 16b are lowered. Hence, the fluid H which returns toward near the inlet portion 11 is involved and converged into the fluid H which is flowing in the direction of the connection passage 13 and has a larger flow rate.

For example, when the increased diameter portion 16a shown in FIG. 2 is provided as in the first embodiment, a large vertical vortex (tumble flow) which swirls in the vertical direction along the laminate direction W of the communication hole 7 can be generated. Hence, the distribution of flow rates becomes favorable in each portion in the laminate direction W, including the flow of the bounced fluid H. Therefore, the fluid H which has flowed from the connection passage 13 into the fluid passage 20 is evenly supplied to each unit cell 4.

In this way, the distribution of flow rates of the fluid H supplied to the membrane electrode assembly 5a portion of each membrane electrode structure 5 is made further uniform, so that each unit cell 4 evenly generates electric power. Therefore, it is possible to stabilize an output voltage and obtain a favorable power generation efficiency with a simple configuration for the fuel cell 1 by employing the manifold structure of the present embodiment.

In contrast, in a comparative example shown in FIG. 5, the fluid H which has flowed into the fluid manifold 10 uniformly flows straight toward the closed portion 12. For this reason, near the closed portion 12, the fluid H which is flowing toward the closed portion 12 interferes with the fluid H which bounces back even in a swirl flow, for example, causing disturbance to inhibit smooth flow. Hence, the static pressure distribution inside the fluid manifold 10 is disturbed, so that the amount of the fluid to be supplied to each unit cell 4 cannot be made uniform.

As shown in FIG. 2, the fuel cell manifold structure of the first embodiment can increase the flow rate of the fluid H at a position near the connection passage 13 side, and can relatively reduce the flow rate at a position away from the connection passage 13 side. Hence, as shown in FIG. 3, the fluid H which has bounced back at the closed portion 12 can flow by the fluid H which is flowing toward the closed portion 12, so that the possibility of interference decreases. Therefore, an occurrence of disturbance near the closed portion 12 is suppressed.

In addition to this, at the position away from the connection passage 13 side, the fluid H smoothly returns toward the inlet portion 11 side, causing a large vertical vortex (tumble flow). The tumble flow has obviously different characteristics of the flow of a vertical vortex from a swirl flow which has the same flow rate no matter whether the flow is close to or away from the connection passage 13 side.

The vertical vortex can increase the flow rate in the laminate direction W on the connection passage 13 side to stabilize the static pressure distribution inside the distribution passage 10c. For this reason, the fluid amount to be supplied to each unit cell 4 in portions in the laminate direction W can be made uniform to improve the power generation efficiency.

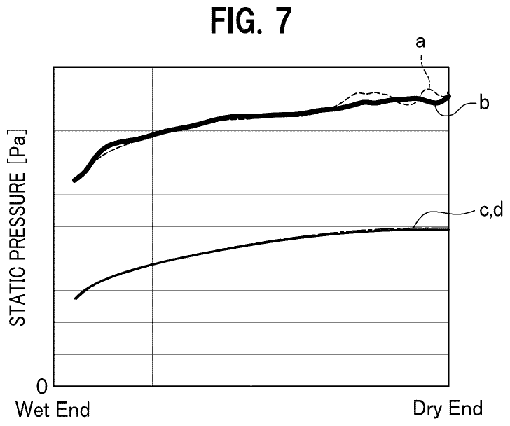

FIG. 7 is a graph for comparing static pressures a and c in the case where the biasing portion 9 is not provided in the inlet portion of the fluid manifold 10 and static pressures b and d in the case where the biasing portion 9 of the first embodiment is provided. Hence, in FIG. 7, a change in static pressure from the inlet portion 11 side (Wet End) to the closed portion 12 side (Dry End) was measured in the laminate direction W of the unit cell 4.

The static pressures a and b of this graph were measured in the respective portions directed in the direction from the inlet portion 11 side toward closed portion 12 of the fluid manifold 10 shown in FIG. 6. In addition, the static pressures c and d of FIG. 7 were measured in the respective portions directed in the direction from the closed portion 12 side toward the case outlet 3e of the discharge-side internal manifold 30 in FIG. 6.

As a result of measurement, it can be seen from the graph of FIG. 7 that the static pressure b in the case where the biasing portion 9 of the first embodiment was provided is stable with a small fluctuation as compared with the static pressure a in the case where the biasing portion 9 was not provided in the inlet portion of the fluid manifold 10. In particular, in the first embodiment, the static pressure on the closed portion 12 side is stable.

Moreover, regarding a change in shapes of the components, it is only necessary to change the shapes of the inner wall surfaces of the pipe-side insulator 15 and the cell-side inlet insulator 16, which can be separated in the inlet portion 11, in the fluid manifold 10.

For this reason, for example, a unit cell 4 and a laminated cell stack 2 which have the same shapes as the other fuel cells can be used, and the effects can be exerted only by setting the shapes of the inlet portion 11 without increasing the cost. Hence, there is no need to change the shape or the like of the active region 8 or the laminated cell stack 2 in which the membrane electrode structure 5 including the membrane electrode assembly 5a is disposed. Therefore, there is also no need to change the design for each fuel cell 1, and thus the number of components can be reduced and an increase in the manufacturing cost can be suppressed.

In addition, it can be seen from the graph of FIG. 7 that the static pressures c and d inside the discharge-side internal manifold 30 were not affected between the case where the biasing portion 9 was formed and the case where the biasing portion 9 was not formed. Therefore, there is no need to change the shape or the like of the laminated cell stack 2 or the discharge-side external manifold 32.

Then, the biasing portion 9 of the first embodiment is formed from separated two members, that is, the pipe-side insulator 15 and the cell-side inlet insulator 16 which is disposed adjacent thereto.

For this reason, even when the shape of the biasing portion 9 is complicated, the biasing portion 9 can be manufactured easily by individually processing each member. For example, in the case of manufacturing each component of the biasing portion 9 by cutting, it is possible to reduce under-cut portions and thus also deal with a complicated shape by processing each of the two members.

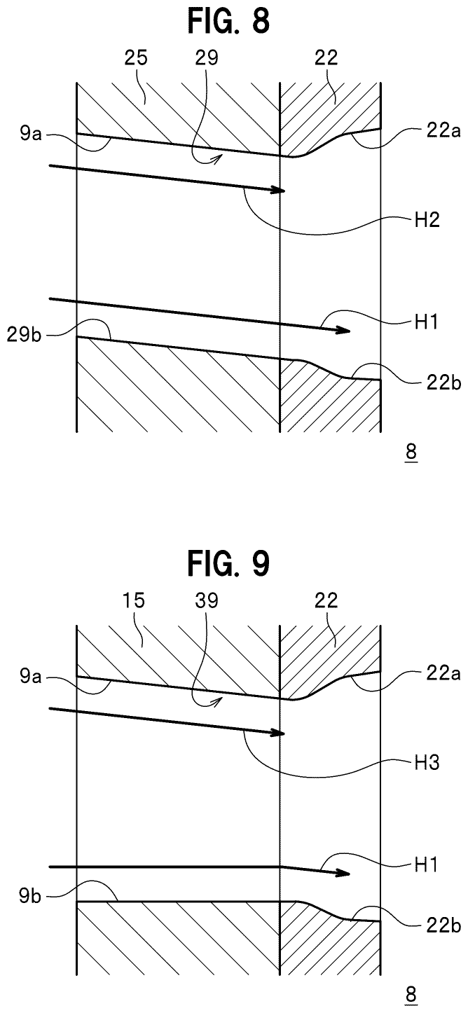

FIG. 8 is a vertical sectional view for explaining a configuration of a biasing portion 29 formed in an inlet portion of a fluid manifold in a fuel cell manifold structure of a second embodiment. Note that portions which are the same as or equivalent to in the biasing portion 9 of the fluid manifold 10 of the first embodiment will be denoted by the same reference signs, and description thereof will be omitted.

The biasing portion 29 of the second embodiment includes a tapered surface 29b in an inner wall on the connection passage 13 side of an end frame-side inlet insulator 21.

The tapered surface 29b is inclined to come closer to the connection passage 13 side as extending toward a closed portion 12, which is not shown, like the tapered surface 9a of the first embodiment.

In addition, the biasing portion 29 of the second embodiment is set such that the diameter-increasing rate of an increased diameter portion 22a which is away from the connection passage 13 side is larger than the diameter-increasing rate of an increased diameter portion 22b which is closer to the connection passage 13 side among the increased diameter portions 22a and 22b of a cell-side inlet insulator 22.

In the fuel cell manifold structure of the second embodiment configured as described above, the tapered surface 29b is inclined to be closer to the connection passage 13 side further in addition to the actions and effects of the biasing portion 9 of the first embodiment. For this reason, in the fuel cell manifold structure of the second embodiment, the flow of the fluid H1 is made faster by biasing the flow to the connection passage 13 side and increasing the flow rate on the connection passage 13 side. In addition, a difference in flow speed can be provided by making the flow of the fluid H2 slower on the side opposite from the connection passage 13 side. This makes it possible to more easily generate a vertical vortex (tumble flow) which flows in one direction in the fluid manifold 10 of the laminated cell stack 2, which is not shown.

In addition, a largely increased diameter of the increased diameter portion 22a at the position away from the connection passage 13 side can further lower the flow speed of the fluid H2 on the side opposite from the connection passage 13 side.

The other configurations as well as the actions and effects are the same as those in the first embodiment, and description thereof will be omitted.

FIG. 9 is a vertical sectional view for explaining a configuration of a biasing portion 39 formed in an inlet portion in a fuel cell manifold structure of a third embodiment. Note that portions which are the same as or equivalent to in the biasing portions 9 and 29 of the fluid manifolds 10 of the first and second embodiments are denoted by the same reference signs, and description thereof will be omitted.

The biasing portion 39 of the third embodiment is configured by combining the pipe-side insulator 15 included in the biasing portion 9 of the first embodiment and the cell-side inlet insulator 22 included in the biasing portion 29 of the second embodiment.

In the fuel cell manifold structure of the third embodiment configured as described above, the following actions and effects can be obtained further in addition to the actions and effects of the biasing portion 9 of the first embodiment.

Specifically, the cell-side inlet insulator 22 of the third embodiment is configured such that the diameter of the increased diameter portion 22a at a position away from the connection passage 13 side is largely increased. This can further lower the flow speed of the fluid H3 on the side opposite from the connection passage 13 side, and thus secure the flow rate of the fluid flowing into the unit cells 4 while biasing the flow of the fluid H1 on the connection passage 13 side.

Hence, practically useful actions and effects can be exerted like being capable of securing a desired flow rate even when the flow speed is fast and the flow rate of the fluid flowing into the unit cells 4 tends to be smaller on the inlet (Wet End) side of the fluid manifold 10.

The other configurations as well as the actions and effects are the same as those in the first embodiment, and description thereof will be omitted.

As mentioned above, the fuel cell manifold structure of the present proposal comprises the laminated cell stack 2 which is provided with the active region by laminating the plurality of unit cells 4 each including the membrane electrode structure 5 and the separator 6. The manifold structure comprises the stack case 3 in which the laminated cell stack 2 is housed. In addition, the manifold structure comprises the fluid manifold 10 which is extended in the laminate direction W of the unit cells 4 of the laminated cell stack 2 to allow the communication holes 7 formed to open in the respective unit cells 4 to communicate with one another, and supplies the fluid H to each unit cell 4. Each of the unit cells 4 includes: the fluid passage 20 which is provided between the membrane electrode structure 5 and the separator 6; and the connection passage 13 which connects the communication hole 7 and the fluid passage 20. The fluid manifold 10 includes: the inlet portion 11 which is provided with the inlet 11a through which the fluid H is allowed to flow into the one end 10a communicating with the outside of the stack case 3; and the closed portion 12 which is located on the other end 10b opposite from the inlet portion 11. Then, the inlet portion 11 is provided with the biasing portion 9 which biases the fluid H flowing into the fluid manifold 10 to the connection passage 13 side.

The fuel cell manifold structure of the present proposal configured as described above can improve the power generation efficiency with a simple configuration. Specifically, the biasing portion 9 biases the fluid H flowing from the inlet portion 11 into the fluid manifold 10 to the connection passage 13 side to increase the flow rate. This reduces the flow rate of the fluid H on the side opposite from the connection passage 13 side. For this reason, the interference of the fluid H which has bounced back at the closed portion 12 of the other end 10b with the fluid H which is flowing toward the closed portion 12 can be reduced, so that the occurrence of disturbance near the closed portion 12 is suppressed.

The fluid H whose traveling direction has been reversed at the closed portion 12 smoothly returns in the direction of the inlet portion 11. For this reason, near the inlet portion 11 inside the fluid manifold 10, the flow rate of the fluid H flowing thereinto becomes large, and the static pressure is increased by the returning fluid H. This stabilizes the static pressure distribution in portions corresponding to the respective unit cells 4 in the direction in which the unit cells 4 of the laminated cell stack 2 are laminated.

In this way, when a difference in static pressure between the inlet portion 11 side and the closed portion 12 side is improved, the fluid amount of the fluid H to be supplied to the fluid passages 20 via the connection passages 13 can be made uniform. Hence, the unit cells 4 having the same shape can be used without increasing the size or changing the shape of the components, and the power generation efficiency can be improved with the simple setting of the shapes of the inlet portions 11 without increasing the cost.

The biasing portion 9 includes the tapered surface 9a which is formed in the inner wall 11b of the inlet portion 11 and is inclined to come closer to the connection passage 13 side as extending from the inlet 11a side toward the closed portion 12 side.

The tapered surface 9a of the biasing portion 9 can efficiently bias the fluid H flowing from the inlet portion 11 into the fluid manifold 10 to further increase the flow rate on the connection passage 13 side.

The tapered surface 9a can be easily formed in the inner wall 11b of the inlet portion 11. Moreover, there is no need to change the shape or structure of the laminated cell stack 2 in which the fluid passages 20 and the active region 8 are provided.

In addition, in the case of connecting another component such as the external manifold 31 to the inlet 11a of the inlet portion 11, there is no need to change the shape associated with an increase in size unlike the conventional structure.

Moreover, the biasing portion 9 includes the straight surface 9b which is provided in parallel with the direction of the center axis L of the fluid manifold 10 on the connection passage 13 side in the inner wall 11b of the inlet portion 11.

The straight surface 9b of the biasing portion 9 can be easily formed in the inner wall 11b of the inlet portion 11. Then, the fluid H can be smoothly supplied to the connection passage 13 side along the straight surface 9b.

This further maintains the flow rate on the connection portion side which is biased, and makes it possible to improve the distribution of flow rates in the laminate direction W, including the flow having bounced back, by shifting the timing of the fluid H reaching to the closed portion 12 side.

Then, the inlet portion 11 of the fluid manifold 10 is configured such that the circle center line SL, which is the center line connecting the center S1 on the inlet 11a side and the center S2 on the closed portion 12 side, is inclined to come closer to the connection passage 13 side as extending from the inlet 11a side toward the closed portion 12 side.

This causes the fluid H to flow in the direction of the circle center line SL inside the inlet portion 11, and can thus further increase the flow rate on the connection passage 13 side.

In addition, the biasing portion 9 is configured such that the size of the passage sectional area on the inlet 11a side of the inlet portion 11 is set to be smaller than the size of the passage sectional area on the closed portion 12 side of the inlet portion 11.

In this way, the biasing portion 9 can separate the fluid H flowing through the inlet portion 11 from the inner wall 11b of the inlet portion 11 to thus reduce the pressure.

Hence, the fluid which is returning toward the inlet portion 11 can be smoothly converged into the flow on the connection passage 13 side which is flowing from the inlet portion 11 toward the closed portion 12 side to generate a large vertical vortex. This can make the static pressure distribution of the fluid H inside the fluid manifold 10 further uniform from the inlet portion 11 side to the closed portion 12 side, thus reducing the unevenness of the flow rate.

In this way, the fuel cell manifold structure of the present proposal can exert practically useful actions and effects such as being capable of easily improving the power generation efficiency with a simple configuration in which the biasing portion 9 is provided in the inlet portion 11 without changing the shapes or the sizes of the other components.

The present invention is not limited to the above-mentioned embodiments, and various modifications can be made. The above-mentioned embodiments are shown as examples for describing the present invention in an easily understandable manner, and the present invention is not necessarily limited to those including all the configurations described above. In addition, it is possible to replace part of the configuration of a certain embodiment with the configuration of another embodiment, and it is also possible to add, to the configuration of a certain embodiment, the configuration of another embodiment. In addition, it is possible to delete part of the configuration of each embodiment, or add another configuration to the configuration or replace the configuration with another configuration. Possible modifications for the above-described embodiments are as described below, for example.

For example, in the embodiments, the biasing portion 9 is formed from separated two members, that is, the pipe-side insulator 15 and the cell-side inlet insulator 16 which is disposed adjacent thereto.

However, the biasing portion 9 is not particularly limited to this, and the biasing portion may be formed by using a single insulator, for example. That is, as long as the biasing portion 9 is provided in a component included in the inlet portion 11, the shape, number, material, and the number of components of the biasing portion 9 are not limited.

In addition, the laminated cell stack 2 of the embodiment is provided with the plurality of dummy cells 14 on each of the inlet portion 11 side or the closed portion 12 side in the laminate direction W. However, the fuel cell manifold structure of the present proposal is not particularly limited to this, and does not have to be provided with the dummy cells 14.

What is claimed is:

1. A fuel cell manifold structure comprising:
a laminated cell stack which is provided with an active region by laminating a plurality of unit cells each including a membrane electrode structure and a separator;
a stack case in which the laminated cell stack is housed; and
a fluid manifold which is extended in a laminate direction of the unit cells of the laminated cell stack to allow communication holes formed to open in the respective unit cells to communicate with one another, and supplies a fluid to each unit cell, wherein
each of the unit cells includes: a fluid passage which is provided between the membrane electrode structure and the separator; and a connection passage which connects the communication hole and the fluid passage,
the fluid manifold includes: an inlet portion which is provided with an inlet through which the fluid is allowed to flow into one end communicating with an outside of the stack case; and a closed portion which is located on another end opposite from the inlet portion, and
the inlet portion is provided with a biasing portion which biases the fluid flowing into the fluid manifold to the connection passage side.

2. The fuel cell manifold structure according to claim 1, wherein the biasing portion includes a tapered surface which is formed in an inner wall of the inlet portion and is inclined to come closer to the active region as extending from the inlet side toward the closed portion side.

3. The fuel cell manifold structure according to claim 1, wherein the biasing portion includes a straight surface which is provided in parallel with a direction of a center axis of the fluid manifold on the connection passage side in the inner wall of the inlet portion.

4. The fuel cell manifold structure according to claim 2, wherein the biasing portion includes a straight surface which is provided in parallel with a direction of a center axis of the fluid manifold on the connection passage side in the inner wall of the inlet portion.

5. The fuel cell manifold structure according to claim 1, wherein the inlet portion of the fluid manifold is configured such that a center line connecting a center on the inlet side and a center on the closed portion side is inclined to come closer to the connection passage side as extending from the inlet side toward the closed portion side.

6. The fuel cell manifold structure according to claim 1, wherein the biasing portion is configured such that a size of a passage sectional area on the inlet side of the inlet portion is set to be smaller than a size of a passage sectional area on the closed portion side of the inlet portion.
